(19) United States
(12) Patent Application Publication
(10) Pub. No.: US 2026/0086446 A1
(43) Pub. Date: Mar. 26, 2026

(54) DISPLAY APPARATUS AND PROJECTION SYSTEM

(71) Applicant: Shanghai Tianma Microelectronics Co., Ltd., Shanghai (CN)

(72) Inventor: Yang ZENG, Shanghai (CN)

(73) Assignee: Shanghai Tianma Microelectronics Co., Ltd., Shanghai (CN)

(21) Appl. No.: 19/253,944

(22) Filed: Jun. 29, 2025

(30) Foreign Application Priority Data
Sep. 20, 2024 (CN) 202411321083.4

(51) Int. Cl. G03B 21/20; G03B 21/00

(52) U.S. Cl. CPC G03B 21/2073; G03B 21/005

(57) ABSTRACT

The present application discloses a display apparatus and a projection system. The display apparatus comprises: a backlight module comprising a display area, and a polarization modulator located on a path of emitted light from the backlight module and comprising a plurality of first sub-areas, wherein at least two of the first sub-areas are refreshed at different time, and/or the display area comprises a plurality of second sub-areas, and at least two of the second sub-areas are refreshed at different time. The display effect of the display apparatus can be improved.

### CROSS-REFERENCE TO RELATED APPLICATION

The present application claims priority to Chinese Patent Application No. 202411321083.4 filed on Sep. 20, 2024, and titled “DISPLAY APPARATUS AND PROJECTION SYSTEM”, which is incorporated herein by reference in its entirety.

### TECHNICAL FIELD

The present application relates to the field of display technology, and specifically, to a display apparatus and a projection system.

### BACKGROUND

Display technology is a main way of interaction between people and the information world, and has been applied in various fields of modern society, such as military, commercial entertainment, education, health care, and industry. The display technology has completely changed people's lifestyle, and is increasingly indispensable for people's daily lives and social activities. For example, a projection device, also known as a projector, is a device that projects images or videos onto a screen for display, and has been widely used in office, home, and other scenarios.

With the development of display technology, the requirement for the display quality of the projection device is increasingly high. Therefore, how to improve the display effect of the projection device is a technical problem that those skilled in the art are committed to researching.

### SUMMARY

Embodiments of the present application provide a display apparatus and a projection system, improving the display effect of the display apparatus can be improved.

In a first aspect, the embodiments of the present application provide a display apparatus, including: a backlight module including a display area, and a polarization modulator located on a path of emitted light from the backlight module and including a plurality of first sub-areas, where at least two of the first sub-areas are refreshed at different time, and/or the display area includes a plurality of second sub-areas, and at least two of the second sub-areas are refreshed at different time.

In a second aspect, embodiments of the present application provide a projection system, including the display apparatus as described in the embodiments of the first aspect.

According to the display apparatus and the projection system provided in the embodiments of the present application, at least two of the first sub-areas are refreshed at different time, so as to differentiate the refresh time for the polarization modulator, which can flexibly match the polarization modulation requirements of different areas of the backlight module, thereby improving the display effect of a final image formed by the light emitted from different areas of the backlight module. In addition, at least two of the second sub-areas are refreshed at different time, so as to differentiate the refresh time for the backlight module, which can flexibly match the refresh time for different areas of the polarization modulator and different areas of the backlight module, thereby better exerting respective performance of different areas of the polarization modulator and different areas of the backlight module.

The above description is only a summary of the technical solutions of the present application. In order to understand the technical means in the present application more clearly, it can be implemented in accordance with the content of the description; and in order to make the above and other objectives, features and advantages of the present application more obvious and easier to understand, and specific implementations of the present application are cited below.

### BRIEF DESCRIPTION OF THE DRAWINGS

Other features, objectives, and advantages of the present invention will become more apparent by reading the following detailed descriptions of non-restrictive embodiments with reference to the accompanying drawings, where the same or similar reference numerals indicate the same or similar features, and the accompanying drawings are not drawn to actual scale.

FIG. 1 illustrates a schematic structural view of a display apparatus provided in an embodiment of the present application;

FIG. 2 illustrates a schematic view of sub-areas of the display apparatus provided in an embodiment of the present application;

FIG. 3 illustrates a schematic structural view of a polarization modulator in the display apparatus provided in an embodiment of the present application;

FIG. 4 illustrates another schematic structural view of the display apparatus provided in an embodiment of the present application;

FIG. 5 illustrates a schematic view of refreshing an row A of pixels and a polarization modulator in a display apparatus in a comparative example;

FIG. 6 illustrates a schematic view of refreshing a row B of pixels and the polarization modulator in the display apparatus in the comparative example;

FIG. 7 illustrates a schematic view of refreshing a row C of pixels and the polarization modulator in the display apparatus in the comparative example;

FIG. 8 illustrates a schematic view of crosstalk in the comparative example;

FIG. 9 illustrates a schematic view of distribution positions of display contents in the comparative example;

FIG. 10 illustrates a schematic view of refreshing an row A of pixels and the polarization modulator in the display apparatus provided in an embodiment of the present application;

FIG. 11 illustrates a schematic view of refreshing a row B of pixels and the polarization modulator in the display apparatus provided in an embodiment of the present application;

FIG. 12 illustrates a schematic view of refreshing a row C of pixels and the polarization modulator in the display apparatus provided in an embodiment of the present application;

FIG. 13 illustrates a schematic view of crosstalk in the display apparatus provided in an embodiment of the present application;

FIG. 14 illustrates a schematic structural view of the display apparatus provided in another embodiment of the present application;

FIG. 15 illustrates a schematic structural view of the display apparatus provided in yet another embodiment of the present application;

FIG. 16 illustrates a schematic structural view of the display apparatus provided in yet another embodiment of the present application;

FIG. 17 illustrates a schematic structural view of the display apparatus provided in yet another embodiment of the present application;

FIG. 18 illustrates a schematic structural view of the display apparatus provided in yet another embodiment of the present application;

FIG. 19 illustrates a schematic structural view of a backlight module in the display apparatus provided in an embodiment of the present application;

FIG. 20 illustrates a schematic view of refreshing corresponding to FIG. 19;

FIG. 21 illustrates a schematic structural view of the display apparatus provided in another embodiment of the present application; and

FIG. 22 illustrates a schematic structural view of the display apparatus provided in another embodiment of the present application.

### DETAILED DESCRIPTION

Features and exemplary embodiments of various aspects of the present application will be described in detail below. In order to make the objectives, technical solutions, and advantages of the present application clearer, the present application will be further described in detail below with reference to the accompanying drawings and specific embodiments. It should be understood that the specific embodiments described herein are only configured to explain the present application, but not configured to limit the present application. For those skilled in the art, the present application can be implemented without some of these specific details. The following descriptions of the embodiments are merely to provide a better understanding of the present invention by showing examples of the present invention.

It should be noted that the relational terms herein, such as first and second, are merely used for distinguishing one entity or operation from another, and do not necessarily require or imply that any actual relationship or sequence exists between these entities or operations. Moreover, the terms “include”, “comprise”, and any variants thereof are intended to cover a non-exclusive inclusion, so that a process, method, article, or device including a series of elements not only includes those elements, but further includes other elements not listed explicitly, or includes inherent elements of the process, method, article, or device. In the absence of more limitations, an element defined by “including . . . ” does not exclude other same elements existing in the process, method, article, or device including the element.

It should be understood that when the structure of a component is described and when one layer or area is referred to as located “on” or “above” other layer or area, the one layer or area may be directly located on the other layer or area, or other layers or areas may be included between the one layer or area and the other layer or area. In addition, if the component is flipped, the one layer or area will be located “below” or “under” the other layer or area.

It should be understood that in this specification, a term “and/or” is only an associative relationship for describing associated objects, indicating that three relationships may exist. For example, A and/or B may indicate three situations: A exists independently; A and B exist simultaneously; and B exists independently. In addition, a character “/” in this specification generally indicates an “or” relationship between contextually associated objects.

In the description of the embodiments of the present application, unless otherwise specified and limited, the technical term “connection” should be understood in a broad sense, for example, the “connection” may be fixed connection, detachable connection, integration, mechanical connection, electrical connection, direct connection, indirect connection by a medium, internal communication of two elements, or interaction between two elements. Those of ordinary skill in the art may appreciate the specific meanings of the foregoing terms in the embodiments of the present application according to specific circumstances.

It is obvious to those skilled in the art that various modifications and changes can be made in the present application without departing from the spirit or scope of the present application. Therefore, the present application is intended to cover the modifications and variations of the present application that fall within the scope of the corresponding claims (technical solutions to be protected) and equivalents thereof. It should be noted that embodiments of the present application can be combined with each other without contradiction.

Embodiments of the present application provide a display apparatus and a projection system, which will be described below with reference to the accompanying drawings.

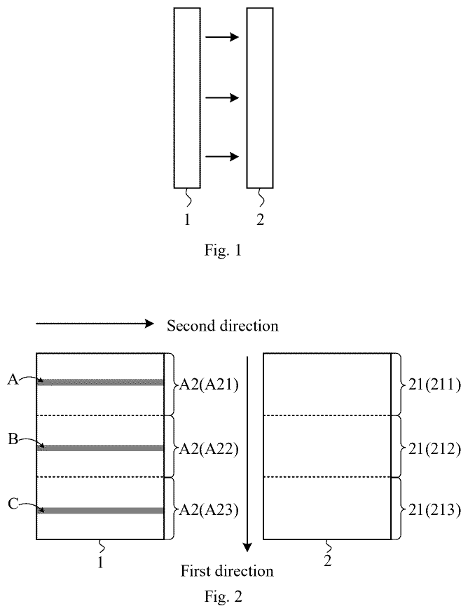

As shown in FIG. 1 and FIG. 2, the display apparatus provided in embodiments of the present application includes a backlight module 1 and a polarization modulator 2. The backlight module 1 includes a display area, which includes sub-pixels capable of emitting light (not shown). The backlight module 1 serves as a light source of the display apparatus. The polarization modulator 2 can modulate the polarization state of light. The polarization modulator may be referred to as PM.

The polarization modulator 2 is located on a path of emitted light from the backlight module 1. It can be understood that, the light emitted from the backlight module 1 can be projected onto the polarization modulator 2. For example, the polarization modulator 2 is located on an output side of the backlight module 1. Here, the “output side” refers to a side that the light emitted from the backlight module 1 can reach directly or reach or point to after being reflected or refracted by another structure. The above-mentioned “side” may be understood as a side of the display apparatus, such as a light output surface or a display surface of the display apparatus.

For example, in the case that the display apparatus is applied to a projection system, the polarization modulator 2 processes the light from the backlight module 1 and projects the processed light onto a projection screen to generate an image.

The polarization modulator 2 includes a plurality of first sub-areas 21, and at least two first sub-areas 21 are refreshed at different time. Additionally or alternatively, the display area of the backlight module 1 includes a plurality of second sub-areas A2, and at least two second sub-areas A2 are refreshed at different time.

It can be understood that, the first sub-areas refreshed at different time modulate the polarization states of light at different time. The second sub-areas refreshed at different time correspond to different light emitting and display time.

The refresh time includes both a refresh moment and a refresh period. For example, that at least two first sub-areas 21 are refreshed at different time includes: the at least two first sub-areas 21 are refreshed at different start moments, additionally or alternatively, the at least two first sub-areas 21 are refreshed in different refresh period.

For example, in one image refresh period of the display apparatus, one first sub-area 21 is refreshed at a first moment, and the other first sub-area 21 is refreshed at a second moment, where the first moment and the second moment are different moments.

For another example, in one image refresh period of the display apparatus, one first sub-area 21 is refreshed in a first period, and the other first sub-area 21 is refreshed in a second period, where the first period and the second period are different periods. At least one of start moment or end moment of the first period is different from that of the second period. For example, the start moments of the first period and the second period are different, and the end moments of the first period and the second period are also different. In some embodiments, different refresh periods can be understood as different stages and relative positions in one display period of the entire apparatus. In some optional embodiments of the present application, different time intervals can be understood as different durations of time.

For example, that at least two second sub-areas A2 are refreshed at different time includes: the at least two second sub-areas A2 are refreshed at different moments; additionally or alternatively, the at least two second sub-areas A2 are refreshed in different periods.

For example, in one image refresh period of the display apparatus, one second sub-area A2 is refreshed at a third moment, and the other second sub-area A2 is refreshed at a fourth moment, where the third moment and the fourth moment are different moments.

For another example, in one image refresh period of the display apparatus, one second sub-area A2 is refreshed in a third period, and the other second sub-area A2 is refreshed in a fourth period, where the third period and the fourth period are different periods. At least one of start moment or end moment of the third period is different from that of the fourth period. For example, the start moments of the third period and the fourth period are different, and the end moments of the third period and the fourth period are also different.

If the entire polarization modulator is refreshed at the same time, the time for modulating the polarization state of all light by the polarization modulator is the same, which is impossible to take into account the differentiated requirements for the polarization modulation of light emitted from different positions on the backlight module. For example, in the case that the light emitted from different areas of the backlight module needs to be modulated by different polarization states, the scheme of refreshing the entire polarization modulator at the same time cannot meet this requirement.

In the embodiments of the present application, at least two first sub-areas are refreshed at different time, so as to differentiate the refresh time of the polarization modulator, which can flexibly match the polarization modulation requirements of different areas of the backlight module, thereby improving the display effect of a final screen formed by the light emitted from different areas of the backlight module. In addition, at least two of the second sub-areas are refreshed at different time, so as to differentiate the refresh time for the backlight module, which can flexibly match the refresh time for different areas of the polarization modulator and different areas of the backlight module, thereby better exerting respective performance of different areas of the polarization modulator and different areas of the backlight module.

In some embodiments, after the first sub-area of the polarization modulator is refreshed, the polarization state of light passing through the first sub-area can be switched.

For example, after the first sub-area is refreshed, the light passing through the first sub-area can be switched from first polarized light to second polarized light. For example, one of the first polarized light and the second polarized light is left circularly polarized (LCP) light, and the other is right circularly polarized (RCP) light. Every time the first sub-area is refreshed, the polarization state of the light changes once. The modulation on the polarization state of the light in the first sub-area remains unchanged between two adjacent refreshes.

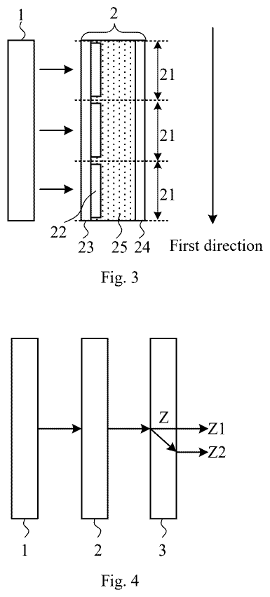

For example, as shown in FIG. 3, the polarization modulator 2 includes a first substrate 23 and a second substrate 24 opposite to each other, a first liquid crystal layer 25 is provided between the first substrate 23 and the second substrate 24, and an electrode 22 is provided on a side of the first substrate 23 facing the second substrate 24. If an electrical signal connected to the electrode 22 is refreshed once, the first sub-area 21 is refreshed once. After the electrical signal connected to the electrode 22 is refreshed, the flipping state of corresponding liquid crystal in the first liquid crystal layer 25 can be changed, thereby modulating the polarization state of light.

For example, if the electrical signal connected to the electrode 22 is switched from a first level to a second level or from a second level to a first level, it is considered that the electrical signal connected to the electrode 22 is refreshed once. One of the first level and the second level is a high level (such as 10 V to 20 V), and the other is a low level (such as 0 V to 2 V). The electrodes 22 in different first sub-areas 21 are disconnected from each other, so that the refresh time for each first sub-area 21 can be controlled separately.

It should be noted that the specific structure of the polarization modulator shown in FIG. 3 is only an example and is not intended to limit the scope of the present application. Any polarization modulator that can achieve area refresh can be applied to the present application.

For example, as shown in FIG. 4, the display apparatus further includes a shifter 3 located on the path of the emitted light from the polarization modulator 2, and the shifter 3 is used for guiding the light of different polarization states to different positions. For example, a first sub-area emits light of a first polarization state before refreshing and light of a second polarization state after refreshing, the light of the first polarization state and the light of the second polarization state are transmitted in a same propagation direction Z to the shifter 3, and the shifter 3 can spatially separate the light of the first polarization state and the light of the second polarization state, so that one of the light of the first polarization state and the light of the second polarization state continues to propagate in the direction Z directly through the shifter 3, such as exits from position Z1, and the other of the light of the first polarization state and the light of the second polarization state turns in the case of passing through the shifter 3 and then exits from position Z2; as a result, in a direction perpendicular to the direction Z, there is a slight pixel offset between an image generated by the light of the first polarization state and an image generated by the light of the second polarization state. In this way, two slightly offset images can be created on a projection screen. Overlaying the two slightly offset images, equivalent to stitching two frames of images into one frame of high-resolution image, can produce an image having a higher resolution than the display apparatus. The pixel offset may be a preset offset, which is not limited in the present application.

For example, the shifter 3 includes a birefringent crystal, which has anisotropy to achieve the displacement of light of different polarization states by the shifter 3. Alternatively, the shifter 3 may be of other structures.

Pixels of the backlight module are refreshed row by row. For example, in FIG. 2, A, B, and C represent three rows of pixels at different positions, and the row B of pixels is roughly a central row of pixels of the backlight module. In one frame, the three rows A, B, and C of pixels are refreshed sequentially, that is, the three rows A, B, and C of pixels are scanned sequentially. The inventor's research found, if the entire polarization modulator is refreshed simultaneously, a good resolution improvement effect cannot be achieved for some rows of pixels. Details are as follows.

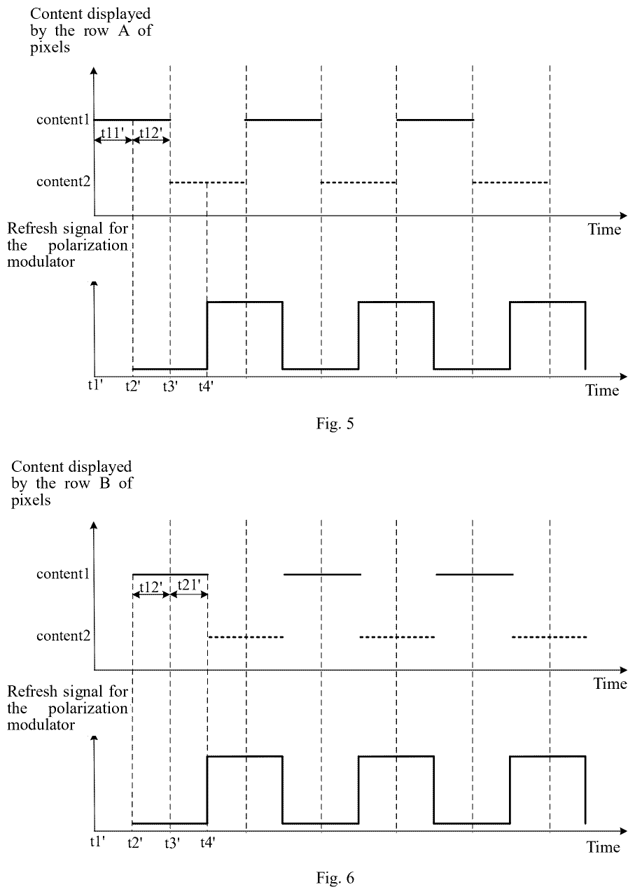

As shown in FIG. 5, the entire polarization modulator is refreshed simultaneously at the time t2′, and the refresh time for the row A of pixels is not the time t2′. The polarization modulator can switch the polarization state of the light passing through after refreshing. For example, the polarization modulator modulates the light emitted by the row A of pixels into light of a first polarization state in the time period t11′, and the polarization modulator modulates the light emitted by the row A of pixels into light of a second polarization state in period t12′. The polarization modulator transmits the modulated light of the row A of pixels to the shifter. After shifted by the shifter, the light emitted by the row A of pixels in period t11′ produces an image at one position, and the light emitted by the row A of pixels in period t12′ produces an image at another position. That is, the content displayed by the row A of pixels after refreshing is ultimately formed at two positions. As a result, the row A of pixels cannot display the content at the same position within a display time after refreshing, and the row A of pixels cannot achieve a good resolution improvement effect.

As shown in FIG. 6, the row B of pixels is refreshed at time t2′, and the entire polarization modulator is refreshed simultaneously at time t2′. That is, the row B of pixels and the entire polarization modulator are refreshed simultaneously. In period t12′ and period t21′, the polarization modulator modulates the light emitted by the row B of pixels into light of the same polarization state. The polarization modulator transmits the modulated light of the row B of pixels to the shifter. After shifted by the shifter, the light emitted by the row B of pixels in period t12′ and period t21′ produces images at the same position. That is, the content displayed by the row B of pixels after refreshing is ultimately formed at the same position, and the row B of pixels can obtain the best resolution improvement effect.

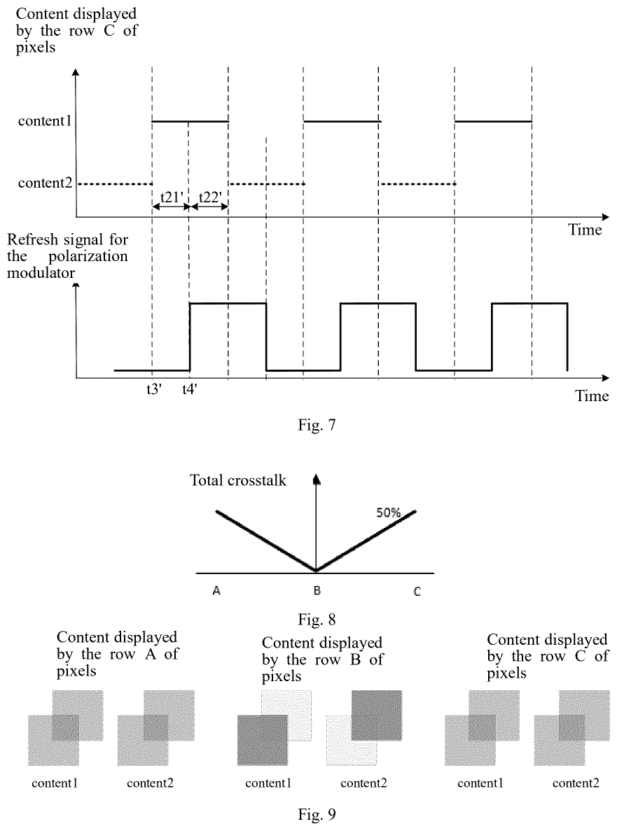

As shown in FIG. 7, the entire polarization modulator is refreshed simultaneously at time t4′, and the refresh time for the row C of pixels is not time t4′. The polarization modulator can switch the polarization state of the light passing through after refreshing. For example, the polarization modulator modulates the light emitted by the row C of pixels into light of a second polarization state in period t21′, and the polarization modulator modulates the light emitted by the row C of pixels into light of a first polarization state in period t22′. The polarization modulator transmits the modulated light of the row C of pixels to the shifter. After shifted by the shifter, the light emitted by the row C of pixels in period t21′ produces an image at one position, and the light emitted by the row C of pixels in period t22′ produces an image at another position. That is, the content displayed by the row C of pixels after refreshing is ultimately formed at two positions. As a result, the row C of pixels cannot display the content at the same position within a display time after refreshing, and the row C of pixels cannot achieve a good resolution improvement effect.

As shown in FIG. 8, it can be understood that the image ultimately generated by the row B of pixels after refreshing is basically free of light crosstalk, while the images ultimately generated by the row A of pixels and the row C of pixels after refreshing have light crosstalk, where the total crosstalk of a row of pixels=incorrect position light intensity/total light intensity. If the content displayed by a row of pixels is ultimately formed at two positions after refreshing, it can be considered that the row of pixels has an incorrect position light intensity.

As shown in FIG. 9, content1 and content2 represent two slightly misaligned image contents, the overlapping parts of the 2 boxes represent two slightly misaligned spatial positions, the deeper filling of the box represents a higher proportion of appearance of light at that position, and the shallower filling of the box represents a lower proportion of appearance of light at that position. For the row A of pixels and the row C of pixels, the light in the two boxes in content1 and content2 is evenly distributed, so the resolutions of the row A of pixels and the row C of pixels cannot be actually increased. For the row B of pixels, the light intensity in content1 is basically distributed in the box at the first position, and the light intensity in content2 is basically distributed in the box at the second position, so the resolution of the row B of pixels can be actually increased.

Thus, if the entire polarization modulator is refreshed simultaneously, the pixels at all positions on the backlight module cannot be balanced, so that only some rows of pixels obtain a resolution improvement effect, while the resolution improvement effect of the pixels away from those positions decreases or even disappears.

In view of this, the entire polarization modulator is no longer refreshed simultaneously in the embodiments of the present application. Instead, the polarization modulator is split into a plurality of first sub-areas, and the at least two first sub-areas are refreshed at different time, so that the polarization modulator can match the refresh time for more rows of pixels in the backlight module, thereby achieving a resolution improvement effect on more rows of pixels.

The following introduces some matching designs between the polarization modulator and the backlight module.

Firstly, design methods of partitioning the polarization modulator in the same direction as a refresh scanning direction of the backlight module are introduced.

In some embodiments, as shown in FIG. 2, the plurality of first sub-areas 21 are arranged in a first direction consistent with a refresh scanning direction of the display area of the backlight module 1.

For example, FIG. 2 illustrates an row A of pixels, a row B of pixels, and a row C of pixels of the backlight module 1, which are arranged in the first direction. The same row of pixels may include a plurality of sub-pixels arranged in a second direction (not shown), the backlight module 1 further includes scanning lines (not shown) that extend in the second direction, and the refresh scanning direction of the display area of the backlight module 1 is perpendicular to the second direction. The refresh scanning direction of the display area of the backlight module 1 in FIG. 2 is the same as the first direction. For example, the row A of pixels is first refreshed, followed by the row B of pixels and the row C of pixels.

In the embodiments of the present application, the arrangement direction of the plurality of first sub-areas is consistent with the refresh scanning direction of the display area of the backlight module, which can match the refresh time for different first sub-areas with the refresh time for pixel rows at different positions more conveniently, thereby achieving the effect of improving the resolutions of more rows of pixels.

It should be noted that there may be other rows of pixels between the row A of pixels and the row B of pixels and between the row B of pixels and the row C of pixels. For example, in practical application or production, the display area of the backlight module does not need to be partitioned, but the rows of pixels of the backlight module are refreshed and scanned row by row to match the refresh time for different rows of pixels, where the refresh time for at least two first sub-areas is set to be different.

As an example, the quantity of the first sub-areas 21 and the quantity of the second sub-areas A2 are the same, and the quantity of the first sub-areas 21 and the quantity of the second sub-areas A2 are both greater than 2. In this way, the plurality of first sub-areas 21 and the plurality of second sub-areas A2 can be matched in one-to-one correspondence, which can match the refresh time for different first sub-areas and the refresh time for different second sub-areas more conveniently, thereby improving the resolutions corresponding to the display area of the entire backlight module.

For example, as shown in FIG. 2, in the case that the quantity of the first sub-areas 21 and the quantity of the second sub-areas A2 are the same, the plurality of second sub-areas A2 are arranged in the refresh scanning direction of the backlight module 1, and the plurality of first sub-areas 21 are arranged in the first direction, where the refresh scanning direction is the same as the first direction.

In some embodiments, the refresh time for a first sub-area is the same as that for at least one corresponding row of pixels in the display area of the backlight module.

Notably, more than 50% of light emitted by a row of pixels can pass through a first sub-area, and it can be considered that the row of pixels and the first sub-area correspond to each other. Similarly, for a second sub-area in the backlight module, if more than 50% of light emitted from the second sub-area can pass through a first sub-area, it can be considered that the second sub-area and the first sub-area correspond to each other.

Optionally, in some embodiments, the light or image emitted from the second sub-area for display overlaps with the corresponding first sub-area in a projection area of a plane where the polarization modulator is located. Or the projection of the light or image provided for display by the second sub-area on the plane where the polarization modulator is located defines the first sub-area.

In the embodiments of the present application, the at least two first sub-areas are refreshed at different time, which can be understood that the two first sub-areas correspond to the refresh time for different rows of pixels. With reference to FIG. 2, for example, one first sub-area corresponds to the row A of pixels, and the refresh time for the first sub-area is the same as that for the row A of pixels, which can ensure that the resolution of the image displayed by the row A of pixels can achieve the best improvement effect. For another example, another first sub-area corresponds to the row B of pixels, and the refresh time for the first sub-area is the same as that for the row B of pixels, which can also ensure that the resolution of the image displayed by the row B of pixels can achieve the best improvement effect. For another example, a further first sub-area corresponds to the row C of pixels, and the refresh time for the first sub-area is the same as that for the row C of pixels, which can also ensure that the resolution of the image displayed by the row C of pixels can achieve the best improvement effect.

In some embodiments, the i^{th} first sub-area is arranged on the path of emitted light from the j^{th} second sub-area, and the refresh time for the i^{th} first sub-area is the same as that for at least one row of pixels in the j^{th} second sub-area, where i and j are both positive integers.

For example, if more than 50% of light emitted from the j^{th} second sub-area can pass through the i^{th} first sub-area, it can be considered that the i^{th} first sub-area is arranged on the path of emitted light from the j^{th} second sub-area, or it can be considered that the i^{th} first sub-area corresponds to the j^{th} second sub-area.

For example, still referring to FIG. 2, FIG. 2 illustrates 3 first sub-areas 21 and 3 second sub-areas A2, where the 1^{st} first sub-area 211 is arranged on the path of emitted light from the 1^{st} second sub-area A21, and the refresh time for the 1^{st} first sub-area 211 is the same as that for at least one row of pixels in the 1^{st} second sub-area A21, which can ensure that the resolution of the image displayed in the 1^{st} second sub-area A21 can achieve the actual improvement effect. The 2^{nd} first sub-area 212 is arranged on the path of emitted light from the 2^{nd} second sub-area A22, and the refresh time for the 2^{nd} first sub-area 212 is the same as that for at least one row of pixels in the 2^{nd} second sub-area A22, which can ensure that the resolution of the image displayed in the 2^{nd} second sub-area A22 can achieve the actual improvement effect. The 3^{rd} first sub-area 213 is arranged on the path of emitted light from the 3^{rd} second sub-area A23, and the refresh time for the 3^{rd} first sub-area 213 is the same as that for at least one row of pixels in the 3^{rd} second sub-area A23, which can ensure that the resolution of the image displayed in the 3^{rd} second sub-area A23 can achieve the actual improvement effect.

In some embodiments, the refresh time for a first sub-area is the same as that for a central row of pixels in the corresponding display area.

Still referring to FIG. 2, the 1^{st} first sub-area 211 corresponds to the 1^{st} second sub-area A21, and the refresh time for the 1^{st} first sub-area 211 is the same as that for the central row of pixels in the 1^{st} second sub-area A21, so that the resolution of the image displayed by the central row of pixels in the 1^{st} second sub-area A21 can achieve the best improvement effect. In addition, the rows of pixels in the second sub-area A21 are refreshed row by row, that is, the refresh time for other rows of pixels in the second sub-area A21 is relatively close to the refresh time for the central row of pixels, so that the refresh time for the other rows of pixels in the second sub-area A21 is not farther from the refresh time for the 1^{st} first sub-area 211, the proportion of shifting the light emitted by the other rows of pixels in the second sub-area A21 to incorrect positions is small, and the 1^{st} first sub-area 211 can better balance the improvement on the resolutions of the images displayed by all the rows of pixels in the 1^{st} second sub-area A21.

Similarly, the 2^{nd} first sub-area 212 corresponds to the 2^{nd} second sub-area A22, and the refresh time for the 2^{nd} first sub-area 212 is the same as that for the central row of pixels in the 2^{nd} second sub-area A22, so that the 2^{nd} first sub-area 212 can better balance the improvement on the resolutions of the images displayed by all the rows of pixels in the 2^{nd} second sub-area A22. The 3^{rd} first sub-area 213 corresponds to the 3^{rd} second sub-area A23, and the refresh time for the 3^{rd} first sub-area 213 is the same as that for the central row of pixels in the 3^{rd} second sub-area A23, so that the 3^{rd} first sub-area 213 can better balance the improvement on the resolutions of the images displayed by all the rows of pixels in the 3^{rd} second sub-area A23.

In some embodiments, the j^{th} second sub-area includes m pixel rows, where m≥2 and is an integer. In the case that m is even, the refresh time for the i^{th} first sub-area is the same as that for the (m/2)^{th} row of pixels or the ((m/2)+1)^{th} row of pixels in the j^{th} second sub-area. In the case that m is odd, the refresh time for the i^{th} first sub-area is the same as that for the ((m+1)/2)^{th} row of pixels in the j^{th} second sub-area.

In the case that m is even, the (m/2)^{th} row of pixels or the ((m/2)+1)^{th} row of pixels can be considered as a central row of pixels of the j^{th} second sub-area. In the case that m is odd, the ((m+1)/2)^{th} row of pixels can be considered as a central row of pixels of the j^{th} second sub-area.

For example, as shown in FIG. 2, the quantity of the second sub-areas A2 is 3, the row A of pixels is a central row of pixels of the 1^{st} second sub-area A21, the row B of pixels is a central row of pixels of the 2^{nd} second sub-area A22, and the row C of pixels is a central row of pixels of the 3^{rd} second sub-area A23. The row A of pixels may be a (1/6)^{th} row of pixels of the backlight module, the row B of pixels may be a (3/6)^{th} row of pixels of the backlight module, and the row C of pixels may be a (5/6)^{th} row of pixels of the backlight module.

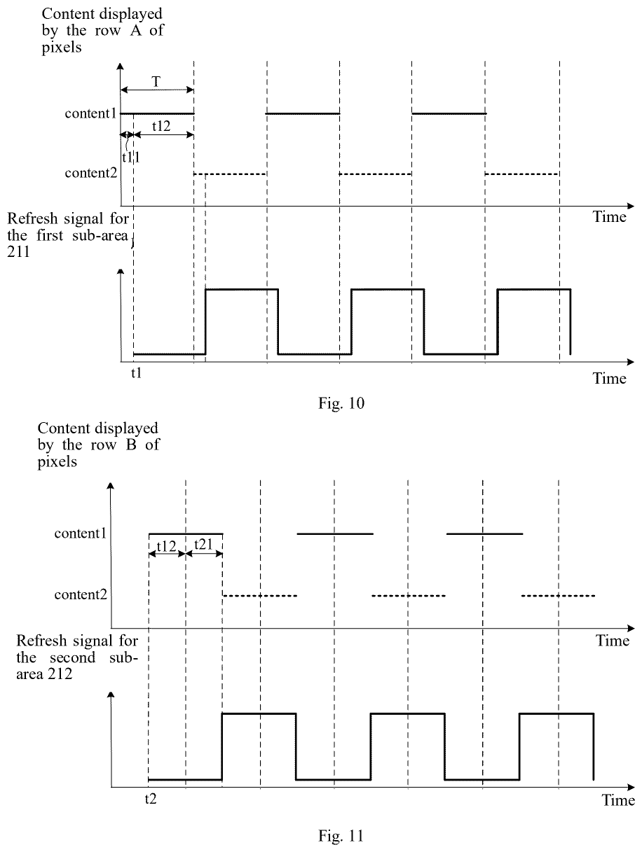

With reference to FIG. 2, FIG. 4, and FIG. 10, the row A of pixels and the 1^{st} first sub-area 211 are refreshed simultaneously at time t1. After refreshing, the 1^{st} first sub-area 211 can switch the polarization state of the light emitted by the row A of pixels. In period t12 after the row A of pixels is refreshed, the 1^{st} first sub-area 211 modulates the light emitted by the row A of pixels into light of the same polarization state. The 1^{st} first sub-area 211 transmits the modulated light of the row A of pixels to the shifter. After shifted by the shifter, the content displayed by the row A of pixels after refreshing is ultimately formed at the same position, and the row A of pixels can achieve the best resolution improvement effect.

With reference to FIG. 2, FIG. 4, and FIG. 11, the row B of pixels and the 2^{nd} first sub-area 212 are refreshed simultaneously at the time t2. After refreshing, the 2^{nd} first sub-area 212 can switch the polarization state of the light emitted by the row B of pixels. In the period t12 and the period t21 after the row B of pixels is refreshed, the 2^{nd} first sub-area 212 modulates the light emitted by the row B of pixels into light of the same polarization state. The 2^{nd} first sub-area 212 transmits the modulated light of the row B of pixels to the shifter. After shifted by the shifter, the content displayed by the row B of pixels after refreshing is ultimately formed at the same position, and the row B of pixels can achieve the best resolution improvement effect.

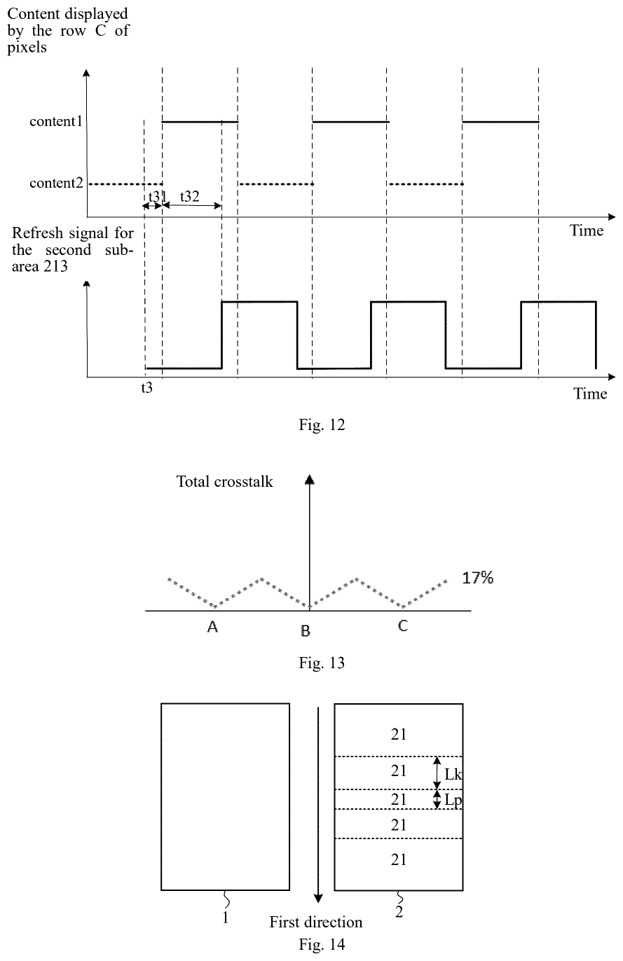

With reference to FIG. 2, FIG. 4, and FIG. 12, the row C of pixels and the 3^{rd} first sub-area 213 are refreshed simultaneously at the time t3. After refreshing, the 3^{rd} first sub-area 213 can switch the polarization state of the light emitted by the row C of pixels. In the period t31 and the period t32 after the row C of pixels is refreshed, the 3^{rd} first sub-area 213 modulates the light emitted by the row C of pixels into light of the same polarization state. The 3^{rd} first sub-area 213 transmits the modulated light of the row C of pixels to the shifter. After shifted by the shifter, the content displayed by the row C of pixels after refreshing is ultimately formed at the same position, and the row C of pixels can achieve the best resolution improvement effect.

As shown in FIG. 13, it can be understood that the images generated by the row A of pixels, the row B of pixels, and the row C of pixels after refreshing are basically free of light crosstalk. Compared to the maximum total crosstalk of 50% shown in FIG. 8, this solution can reduce the maximum total crosstalk to 17%. In addition, contrast=(correct position light intensity-incorrect position light intensity)/total light intensity, and reducing crosstalk reduces the incorrect position light intensity, thereby increasing contrast and improving resolution.

It can be understood that the more first sub-areas the polarization modulator is partitioned into, the more pixel rows can be refreshed synchronously with the first sub-areas one by one, thereby reducing total crosstalk and improving overall resolution.

The above examples introduce some design methods of partitioning the polarization modulator in the same direction as the refresh scanning direction of the backlight module, and how to match the refresh time. In addition, on the basis of partitioning the polarization modulator in the same direction as the refresh scanning direction of the backlight module, the polarization modulator can be partitioned or have a partitioning size as follows.

In some embodiments, the plurality of first sub-areas are arranged in the first direction, and each first sub-area has the same length in the first direction.

That is, the polarization modulator is uniformly partitioned into the plurality of first sub-areas in the first direction. As shown in FIG. 2, the first direction is consistent with the refresh scanning direction of the backlight module 1. In the case that each first sub-area 21 has the same length, the display area of the backlight module corresponding to each first sub-area 21 in the first direction is also the same, or the plurality of second sub-areas A2 also have the same length in the first direction, making the resolution of the image ultimately formed by the display apparatus uniform.

In other embodiments, the plurality of first sub-areas are arranged in the first direction, and at least two first sub-areas have different lengths in the first direction.

That is, the polarization modulator is divided into the plurality of first sub-areas in the first direction in a non-uniform manner. As shown in FIG. 14, the first direction is consistent with the refresh scanning direction of the backlight module 1, and the longer the first sub-area 21, the more the pixel rows corresponding to the first sub-area 21. In the first direction, the shorter the first sub-area 21, the fewer the corresponding pixel rows of the backlight module. That is, in the first direction, if the first sub-area is longer, the light emitted by more rows of pixels can pass through the first sub-area, then the first sub-area needs to take account of more pixel rows, so that pixels refreshed at significantly different time from the first sub-area are prone to exist. In the first direction, if the first sub-area is shorter, the light emitted by fewer pixel rows can pass through the first sub-area, the first sub-area needs to take account of fewer pixel rows, so that pixels refreshed at significantly different time from the first sub-area are not prone to exist. It can be understood that, in the first direction, the shorter first sub-area is more advantageous to improving resolution.

In the embodiments of the present application, different lengths of the first sub-areas are set differentially in the first direction to facilitate flexible matching of resolution requirements for different positions.

In some embodiments, as shown in FIG. 14, in the arrangement direction of the plurality of first sub-areas, the length of the p^{th} first sub-area is Lp, the length of the k^{th} first sub-area is Lk, and the p^{th} first sub-area is closer to a center of the polarization modulator than the k^{th} first sub-area, where Lp<Lk.

The first direction is consistent with the refresh scanning direction of the backlight module 1. In the first direction, the first sub-area closer to the center of the polarization modulator is shorter; and the first sub-area farther from the center of the polarization modulator is longer. For example, in the case that the display apparatus is applied to a projection system, in the first direction, the image projected by the first sub-area closer to the center of the polarization modulator is closer to the center of the entire projected image, and the image projected by the first sub-area farther from the center of the polarization modulator is closer to the edge of the entire projected image. In the embodiments of the present application, the first sub-area closer to the center of the polarization modulator is shorter, so that the center resolution of the projected image can be greater than the edge resolution of the projected image, thereby better improving the display effect of the center area focused by human eyes.

As mentioned above, the more the first sub-areas, the more it is advantageous to improving the overall resolution. However, if there are more first sub-areas, the process will become more difficult and the driving timing will become more complicated. In the embodiments of the present application, in the first direction, the first sub-area closer to the center of the polarization modulator is shorter, and the first sub-area farther from the center of the polarization modulator is longer, so that more first sub-areas are in the center area of the polarization modulator than in the edge area, and most of the limited quantity of first sub-areas can be distributed in the center, which can avoid an excessive total quantity of first sub-areas to increase the process difficulty and the complexity of the driving timing, and can also consider the resolution of the center of the image focused by human eyes.

The above examples introduced the partitioning method and partitioning size of the polarization modulator.

In order to better ensure the modulation effect of the polarization modulator on light and the final resolution improvement effect, the structural features of the polarization modulator and the associated structural features of the polarization modulator and the backlight module can be further designed as follows.

In some embodiments, as shown in FIG. 3, the polarization modulator 2 includes electrodes 22 and a first liquid crystal layer 25. Electrical signals connected to the electrodes 22 can be used for controlling the flipping of liquid crystal in the first liquid crystal layer 25, thereby modulating the polarization state of light.

The electrodes 22 in different first sub-areas 21 are disconnected from each other. It can be understood that, there is a slit between the electrodes 22 in different first sub-areas 21, and the slit between the electrodes 22 can be as small as possible to avoid affecting the modulation effect on the polarization state of light.

For example, the plurality of first sub-areas 21 are arranged in the first direction, the distance between two of the electrodes 22 in the adjacent first sub-areas 21 is Ld, and the minimum length of the plurality of first sub-areas 21 is Lm, where Ld<Lm. That is, in the first direction, the length of the slit between the electrodes 22 is less than the minimum length of the plurality of first sub-areas 21.

In some embodiments, the plurality of first sub-areas 21 are arranged in the first direction, the distance between two of the electrodes 22 in the adjacent first sub-areas 21 is Ld, Ld is less than a first preset threshold, and the first preset threshold is less than or equal to 10 micrometers (μm).

The first preset threshold is a maximum value preset to ensure the modulation effect of the polarization modulator on the polarization state of light.

For example, Ld may be less than or equal to 3 micrometers (μm). It can be understood that, Ld is greater than 0.

For example, the plurality of first sub-areas are arranged in the first direction, the first direction is consistent with the refresh scanning direction of the backlight module, the pixels in the backlight module need to have a corresponding relationship with the first sub-areas of the polarization modulator, and the light emitted by each pixel cannot pass through a large quantity of first sub-areas simultaneously, otherwise the resolution improvement effect corresponding to the pixel will be reduced.

In view of this, the polarization modulator and the backlight module can be arranged close to each other, that is, the distance between the polarization modulator and the backlight module is relatively short.

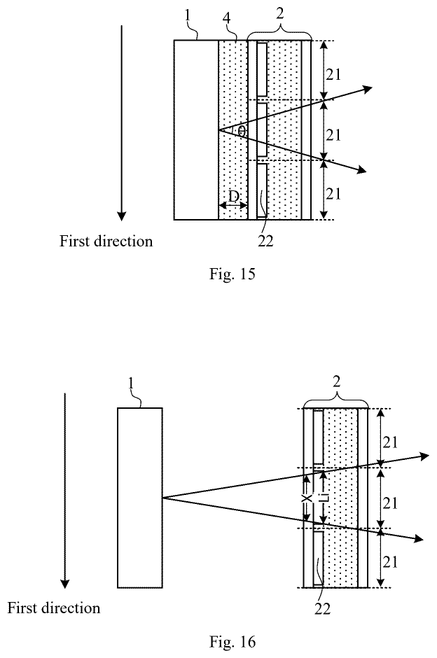

For example, as shown in FIG. 15, the distance between a light output surface of the backlight module 1 and the polarization modulator 2 is D, where D≤10 mm (millimeters).

The maximum value of D is a maximum value preset to ensure that the light emitted by the pixel cannot pass through a large quantity of first sub-areas simultaneously. In the embodiments of the present application, the polarization modulator and the backlight module are arranged close to each other, so even if the light emitting aperture angle θ of the backlight module is relatively large, the light emitted by the pixel can be prevented from passing through a large quantity of first sub-areas simultaneously, thereby ensuring the resolution improvement effect of the pixel.

In some embodiments, as shown in FIG. 15, the light output surface of the backlight module 1 is connected to the polarization modulator 2 by an optical adhesive layer 4. The optical adhesive layer 4 has viscosity and can connect the backlight module 1 with the polarization modulator 2. The optical adhesive layer 4 is transparent and almost does not change the transmission path of light.

In some embodiments, the distance D between the light output surface of the backlight module 1 and the polarization modulator 2 is ≥1 mm.

For example, the maximum value of D is a minimum value preset to ensure the stability of connection between the backlight module 1 and the polarization modulator 2. The backlight module 1 and the polarization modulator 2 are connected by the optical adhesive layer 4, and the distance D determines the thickness of the optical adhesive layer 4. If the optical adhesive layer 4 is too thin, the stability of connection between the backlight module 1 and the polarization modulator 2 will be reduced. In the embodiments of the present application, the distance D≥1 mm can prevent the optical adhesive layer 4 from being too thin, thereby ensuring the stability of connection between the backlight module 1 and the polarization modulator 2.

In other embodiments, a design can be conducted from another perspective to prevent the light emitted by a pixel from passing through a large quantity of first sub-areas simultaneously. For example, as shown in FIG. 16, the plurality of first sub-areas 21 are arranged in the first direction, where the first direction may be consistent with the refresh scanning direction of the backlight module. A cross-section where the light emitted by the pixel in the backlight module 1 is projected onto the polarization modulator 2 has a length of X in the first direction, and a total length of the plurality of first sub-areas in the first direction is Y, where X<Y/2. This ensures that the light emitted by the pixel of the backlight module does not pass through a large quantity of first sub-areas simultaneously.

For example, in the first direction, the length of each first sub-area is y1, and the quantity of the first sub-areas is n1, where Y=n1*y1.

Optionally, the i^{th} first sub-area is arranged on the path of light emitted by the pixels in the backlight module 1, and in the first direction, the length of the i^{th} first sub-area is Li, where X<Li.

Herein, in the case that the first sub-area includes an electrode, the length of the electrode in the first sub-area can be taken as the length of the first sub-area in the first direction.

The above examples introduce the structural features of the polarization modulator and the associated structural features of the polarization modulator and the backlight module. It should be noted that the above examples are not intended to limit the present application. In other examples, the structural features of the polarization modulator and the associated structural features of the polarization modulator and the backlight module can also be designed in other ways.

The following introduces other structural features of the display apparatus.

In some embodiments, the display apparatus includes n backlight modules for emitting monochromatic light, and the n backlight modules emit light of different colors. The display apparatus further includes a color combiner, which is arranged on a path of light emitted by the n backlight modules to combine the colors of the light emitted by the n backlight modules. The color combiner combines the colors to generate a white image, so as to meet the watching effect. For example, the color combiner may be located between the backlight module and the polarization modulator, or the polarization modulator is located between the backlight module and the color combiner.

In some embodiments, the display apparatus further includes a shifter located on the path of emitted light from the polarization modulator, and the shifter is used for shifting the light of different polarization states to create two slightly offset images on the projection screen. For example, if the shifter is located between the polarization modulator and the projection screen, or in the case that the polarization modulator is located between the backlight module and the color combiner, the shifter is located between the color combiner and the projection screen.

The display apparatus provided in the embodiments of the present application may be applied to a projection apparatus. In order to meet the watching effect, the display apparatus can project white images. In order to project the white images, the backlight module may include sub-pixels of a plurality of colors.

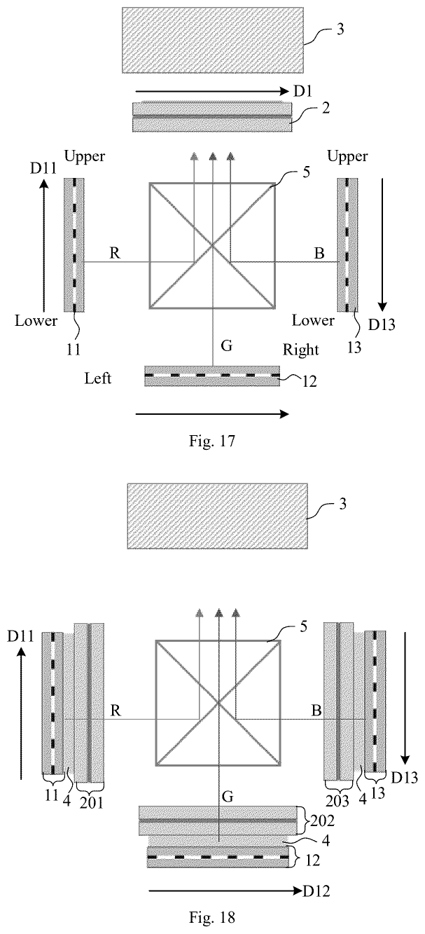

As an example, as shown in FIG. 17, the quantity of backlight modules is n, the display apparatus further includes a color combiner 5 and a shifter 3, the color combiner 5 combines the colors of light emitted by the n backlight modules (labeled 11, 12, and 13 respectively) and transmits the color-combined light to the polarization modulator 2, and the polarization modulator 2 transmits the modulated light to the shifter 3, where n≥2 and n is an integer.

In this example, the color combiner 5 is located between the backlight modules and the polarization modulator 2, and the n backlight modules share the same polarization modulator 2. The transmission path of light is as follows: the light emitted by the backlight modules is transmitted to the color combiner 5, the color combiner 5 transmits the color-combined light to the polarization modulator 2, the polarization modulator 2 transmits the modulated light to the shifter 3, the shifter 3 can project the light onto a projection screen (not shown), and the light forms two slightly offset images on the projection screen.

For example, the n backlight modules are a first backlight module 11, a second backlight module 12, and a third backlight module 13 respectively. The first backlight module 11 can emit red light R, the second backlight module 12 can emit green light G, and the third backlight module 13 can emit blue light B. The color combiner 5 can combine the light R, G, and B into white light, thereby ultimately projecting white images.

Because the n backlight modules share the same polarization modulator 2, in order to match the refresh time for the first sub-areas in the same polarization modulator 2 with the refresh time for the n backlight modules, the refresh time for the n backlight modules is the same in some embodiments. For example, the refresh start time for the n backlight modules is the same, and the refresh end time for the n backlight modules is the same.

In some embodiments, in the case that the n backlight modules share the same polarization modulator 2, the n backlight modules each include the same quantity of pixel rows, and the pixel rows used for color combination together in the n backlight modules are refreshed at the same time.

For example, as shown in FIG. 17, each backlight module includes 100 rows of pixels. In FIG. 17, the first backlight module 11 and the third backlight module 13 are distributed on two sides of the color combiner 5 respectively. For ease of explanation, the upper and lower sides of the first backlight module 11 and the third backlight module 13 are marked, and the left and right sides of the second backlight module 12 are marked.

For example, for the first backlight module 11, a 1^{st} row of pixels to a 100^{th} row of pixels are arranged from its upper side to its lower side, and its refresh scanning direction is D11, that is, refresh scanning is performed from its 100^{th} row of pixels to its 1^{st} row of pixels.

For example, for the third backlight module 13, a 1^{st} row of pixels to a 100^{th} row of pixels are arranged from its upper side to its lower side, and its refresh scanning direction is D13, that is, refresh scanning is performed from its 1^{st} row of pixels to its 100^{th} row of pixels.

For example, for the second backlight module 12, a 1^{st} row of pixels to a 100^{th} row of pixels are arranged from its left side to its right side, and its refresh scanning direction is D12, that is, refresh scanning is performed from its 1^{st} row of pixels to its 100^{th} row of pixels.

The 100^{th} row of pixels of the first backlight module 11, the 1^{st} row of pixels of the second backlight module 12, and the 1^{st} row of pixels of the third backlight module 13 are pixel rows used for color combination together; the 99^{th} row of pixels of the first backlight module 11, the 2^{nd} row of pixels of the second backlight module 12, and the 2^{nd} row of pixels of the third backlight module 13 are pixel rows used for color combination together; the 98^{th} row of pixels of the first backlight module 11, the 3^{rd} row of pixels of the second backlight module 12, and the 3^{rd} row of pixels of the third backlight module 13 are pixel rows used for color combination together; the 1^{st} row of pixels of the first backlight module 11, the 100^{th} row of pixels of the second backlight module 12, and the 100^{th} row of pixels of the third backlight module 13 are pixel rows used for color combination together.

For example, the polarization modulator 2 has 3 first sub-areas arranged in the first direction D1 and from left to right, where the refresh time for the middle first sub-area is the same as that for the 50^{th} row of pixels of the first backlight module 11, the 51^{th} row of pixels of the second backlight module 12, and the 51^{th} row of pixels of the third backlight module 13; the refresh time for the first sub-area on the left side is the same as that for the 75^{th} row of pixels of the first backlight module 11, the 26^{th} row of pixels of the second backlight module 12, and the 26^{th} row of pixels of the third backlight module 13; the refresh time for the first sub-area on the right side is the same as that for the 26^{th} row of pixels of the first backlight module 11, the 75^{th} row of pixels of the second backlight module 12, and the 75^{th} row of pixels of the third backlight module 13.

In other embodiments, a plurality of backlight modules and a plurality of polarization modulators may be arranged in one-to-one correspondence. Specifically, as shown in FIG. 18, the display apparatus includes n backlight modules (labeled 11, 12, and 13 respectively) and n polarization modulators (labeled 201, 202, and 203 respectively), and further includes a color combiner 5 and a shifter 3, where the n backlight modules and the n polarization modulators are arranged in one-to-one correspondence, the n polarization modulators modulate the light emitted by the n backlight modules and transmit the modulated light to the color combiner 5 respectively, and the color combiner 5 combines the colors of the light output by the n polarization modulators and then outputs the color-combined light to the shifter 3, where n≥2 and n is an integer.

In this example, the polarization modulators are located between the color combiner 5 and the backlight modules, and one backlight module corresponds to one polarization modulator. The transmission path of light is as follows: the light emitted by the backlight modules is transmitted to the polarization modulators, the polarization modulators transmit the modulated light to the color combiner 5, the color combiner 5 transmits the color-combined light to the shifter 3, the shifter 3 can project the light onto a projection screen (not shown), and the light forms two slightly offset images on the projection screen.

For example, the n backlight modules are respectively a first backlight module 11, a second backlight module 12, and a third backlight module 13; and the n polarization modulators are respectively a first polarization modulator 201, a second polarization modulator 202, and a third polarization modulator 203. The first polarization modulator 201 corresponds to the first backlight module 11, the second polarization modulator 202 corresponds to the second backlight module 12, and the third polarization modulator 203 corresponds to the third backlight module 13. The refresh time for each polarization modulator only needs to match the refresh time for the corresponding backlight module.

For example, the refresh directions of the first polarization modulator 201 and the first backlight module 11 are D11, the refresh directions of the second polarization modulator 202 and the second backlight module 12 are D12, and the refresh directions of the third polarization modulator 203 and the third backlight module 13 are D13.

In the above embodiments, in a case that there are backlight modules in number of n, at least one backlight module is used for emitting monochromatic light.

In other embodiments, in the case that the backlight module can display white images, the color combiner may not be configured.

For example, the backlight module includes sub-pixels of first to N^{th} colors, the same row of pixels may include different colors of sub-pixels, the different colors of sub-pixels in the same row of pixels are refreshed simultaneously, and the polarization modulator modulates the light emitted from the backlight module and then transmits the modulated light to the shifter.

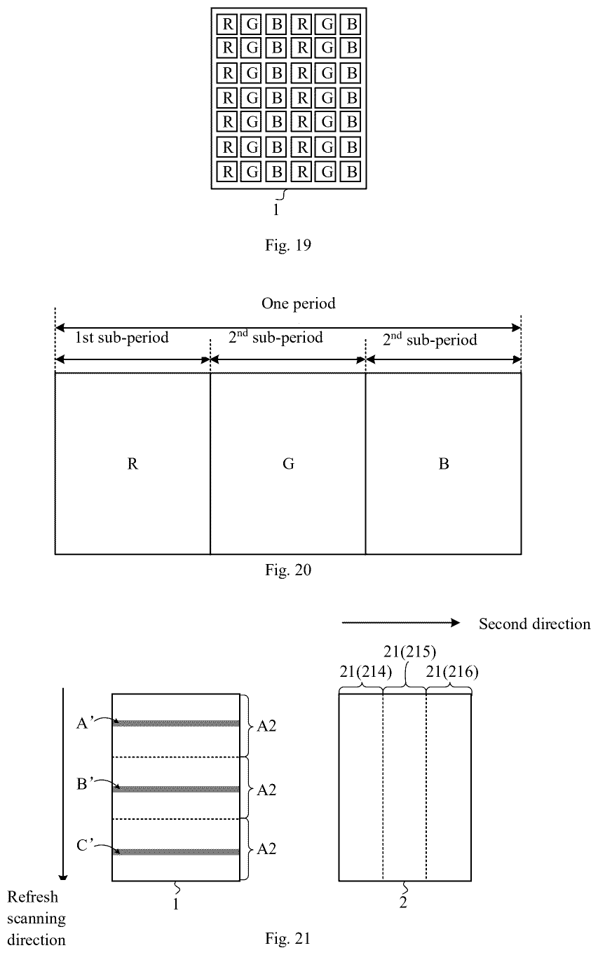

For example, with reference to FIG. 4 and FIG. 19, the backlight module includes sub-pixels capable of emitting red light R, sub-pixels capable of emitting green light G, and sub-pixels capable of emitting blue light B. At the same refresh time, the sub-pixels capable of emitting red light R, the sub-pixels capable of emitting green light G, and the sub-pixels capable of emitting blue light B can be refreshed and scanned simultaneously, so that the backlight module can display white images.

It should be noted that the arrangement of each color of sub-pixels shown in FIG. 19 is only an example and is not intended to limit the present application.

For example, the backlight module includes sub-pixels of first to N^{th} colors, and one period of the backlight module sequentially includes N sub-periods. In the N^{th} sub-period, the sub-pixels of the N^{th} color emit light. In any sub-period, the at least two first sub-areas are refreshed at different time.

For example, with reference to FIGS. 2, 4, 19, and 20, the backlight module includes sub-pixels capable of emitting red light R, sub-pixels capable of emitting green light G, and sub-pixels capable of emitting blue light B.

In the 1^{st} sub-period, different rows of sub-pixels for emitting red light R are refreshed and scanned, and the backlight module displays a red image in the 1^{st} sub-period. Additionally, in the 1^{st} sub-period, the at least two first sub-areas of the polarization modulator are refreshed at different time. For example, in the 1^{st} sub-period, the (1/6)^{th} row of sub-pixels for emitting red light R is refreshed and scanned, while the 1^{st} first sub-area 211 is refreshed.

In the 1^{st} sub-period, the (3/6)^{th} row of sub-pixels for emitting red light R is refreshed and scanned, while the 2^{nd} first sub-area 212 is refreshed. In the 1^{st} sub-period, the (5/6)^{th} row of sub-pixels for emitting red light R is refreshed and scanned, while the 3^{rd} first sub-area 213 is refreshed.

In the 2^{nd} sub-period, different rows of sub-pixels for emitting green light G are refreshed and scanned, and the backlight module displays a green image in the 2^{nd} sub-period. Additionally, in the 2^{nd} sub-period, the at least two first sub-areas of the polarization modulator are refreshed at different time. For example, in the 2^{nd} sub-period, the (1/6)^{th} row of sub-pixels for emitting green light G is refreshed and scanned, while the 1^{st} first sub-area 211 is refreshed. In the 2^{nd} sub-period, the (3/6)^{th} row of sub-pixels for emitting green light G is refreshed and scanned, while the 2^{nd} first sub-area 212 is refreshed. In the 2^{nd} sub-period, the (5/6)^{th} row of sub-pixels for emitting green light G is refreshed and scanned, while the 3^{rd} first sub-area 213 is refreshed.

In the 3^{rd} sub-period, different rows of sub-pixels for emitting blue light B are refreshed and scanned, and the backlight module displays a blue image in the 3^{rd} sub-period. Additionally, in the 3^{rd} sub-period, the at least two first sub-areas of the polarization modulator are refreshed at different time. For example, in the 3^{rd} sub-period, the (1/6)^{th} row of sub-pixels for emitting blue light B is refreshed and scanned, while the 1^{st} first sub-area 211 is refreshed. In the 3^{rd} sub-period, the (3/6)^{th} row of sub-pixels for emitting blue light B is refreshed and scanned, while the 2^{nd} first sub-area 212 is refreshed. In the 3^{rd} sub-period, the (5/6)^{th} row of sub-pixels for emitting blue light B is refreshed and scanned, while the 3^{rd} first sub-area 213 is refreshed.

It should be noted that any of the above examples is applicable to the situation that the arrangement direction of the first sub-areas is consistent with the refresh scanning direction of the backlight module.

Alternatively, in other examples, the arrangement direction of the first sub-areas may be inconsistent with the refresh scanning direction of the backlight module.

In some embodiments, as shown in FIG. 21, at least two first sub-areas 21 are arranged in a second direction, and the second direction is perpendicular to the refresh scanning direction of the display area of the backlight module 1. The refresh time for the at least two first sub-areas 21 is consistent with the refresh time for different pixel rows in the display area of the backlight module 1, respectively.

For example, the backlight module 1 includes an A′ row of pixels, a B′ row of pixels, and a C′ row of pixels, which are arranged in the refresh scanning direction. Here, it can be understood that the second direction is consistent with the extension direction of scanning lines in the backlight module 1.

For example, the refresh time for the first sub-area 214 is the same as that for the A′ row of pixels, the refresh time for the first sub-area 215 is the same as that for the B′ row of pixels, and the refresh time for the first sub-area 216 is the same as that for the C′ row of pixels. Here, the refresh time includes both a refresh moment and a refresh period.

The light emitted by the A′ row of pixels, the B′ row of pixels, and the C′ row of pixels all passes through the first sub-area 214. In the case that the refresh time for the first sub-area 214 is the same as that for the A′ row of pixels, the resolution corresponding to the A′ row of pixels can be better improved. The light emitted by the A′ row of pixels, the B′ row of pixels, and the C′ row of pixels all passes through the first sub-area 215. In the case that the refresh time for the first sub-area 215 is the same as that for the B′ row of pixels, the resolution corresponding to the B′ row of pixels can be better improved. The light emitted by the A′ row of pixels, the B′ row of pixels, and the C′ row of pixels all passes through the first sub-area 216. In the case that the refresh time for the first sub-area 216 is the same as that for the C′ row of pixels, the resolution corresponding to the C′ row of pixels can be better improved. Compared to refreshing the entire polarization modulator simultaneously, the embodiments of the present application can better improve the resolutions corresponding to more rows of pixels.

Of course, this partitioning method can also be selectively designed to be compatible with partitioning the polarization modulator in the same direction as the refresh scanning direction of the backlight module. Details are not repeated here.

In some embodiments, as shown in FIG. 21, in the case that at least two first sub-areas 21 are arranged in the second direction, the plurality of second sub-areas A2 of the backlight module 1 include an e^{th} second sub-area and an f^{th} second sub-area, where the refresh time for one first sub-area is the same as that for at least one row of pixels in the e^{th} second sub-area, and the refresh time for another first sub-area is the same as that for at least one row of pixels in the f^{th} second sub-area.

The A′ row of pixels, the B′ row of pixels, and the C′ row of pixels belong to different second sub-areas A2, the refresh time for the first sub-area 214 is the same as that for the A′ row of pixels, the refresh time for the first sub-area 215 is the same as that for the B′ row of pixels, and the refresh time for the second sub-area 216 is the same as that for the C′ row of pixels.

For example, the A′ row of pixels, the B′ row of pixels, and the C′ row of pixels are central rows of pixels of different second sub-areas A2, respectively.

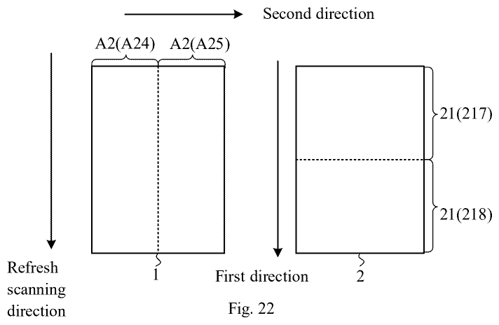

In some embodiments, as shown in FIG. 22, at least two second sub-areas A2 in the backlight module 1 are arranged in the second direction, and the second direction is perpendicular to the refresh scanning direction of the display area of the backlight module 1. Here, it can be understood that the second direction is consistent with the extension direction of scanning lines in the backlight module 1. Moreover, the at least two second sub-areas A2 are refreshed at different time, and the two second sub-areas A2 refreshed at different time have a same refresh frequency.

For example, the refresh frequencies of the two second sub-areas A2 arranged in the second direction are both 120 Hz, but the refresh start time for the two second sub-areas A2 is different. For example, in FIG. 22, the refresh start time for the second sub-area labeled A24 is prior to that for the second sub-area labeled A25, but the refresh frequencies of the second sub-area labeled A24 and the second sub-area labeled A25 are the same. To put it simply, for two second sub-areas refreshed at different time with the same frequency, one second sub-area is refreshed earlier than the other second sub-area.

In the embodiments of the present application, by differentiating the refresh time for different second sub-areas A2 arranged in the second direction, the refresh time for different second sub-areas A2 can match the corresponding refresh time for the polarization modulator, thereby flexibly meeting different display requirements.

Optionally, in some embodiments, the polarization modulator may be driven bilaterally, and driving circuits are arranged on different sides corresponding to different second sub-areas.

In some embodiments, as shown in FIG. 22, in the case that at least two second sub-areas A2 are arranged in the second direction in the backlight module 1, the plurality of first sub-areas 21 of the polarization modulator 2 are arranged in the first direction, and the first direction is consistent with the refresh scanning direction of the display area of the backlight module 1.

For example, the at least two first sub-areas are refreshed at different time. For example, the refresh time for the first sub-area labeled 217 is the same as that for the second sub-area labeled A24, and the refresh time for the first sub-area labeled 218 is the same as that for the second sub-area labeled A25.

For example, the refresh time for the first sub-area labeled 217 is the same as that for at least one row of pixels in the second sub-area labeled A24, and the refresh time for the first sub-area labeled 218 is the same as that for at least one row of pixels in the second sub-area labeled A25.

For example, the refresh time for the first sub-area labeled 217 is the same as that for the central row of pixels in the second sub-area labeled A24, and the refresh time for the first sub-area labeled 218 is the same as that for the central row of pixels in the second sub-area labeled A25.

Embodiments of the present application further provide a projection system, including the display apparatus provided in any of the above embodiments. It can be understood that the projection system provided in the embodiment of the present application has the beneficial effects of the display apparatus provided in any of the above embodiments, which will not be elaborated here.

According to the embodiments described above in the present application, these embodiments do not provide a detailed description of all the details, nor do they limit the present application to only the described specific embodiments. Apparently, many modifications and changes may be made to the above description. This specification selects and specifically describes these embodiments in order to better explain the principles and practical applications of the present application, so that those skilled in the art can make good use of the present application and modifications based on the present application. The present application is merely limited by the claims and all their scope and equivalents.

What is claimed is:

1. A display apparatus, comprising:
a backlight module comprising a display area; and
a polarization modulator located in a path of emitted light from the backlight module and comprising a plurality of first sub-areas,
wherein at least two of the plurality of first sub-areas have different refresh times, and/or the display area comprises a plurality of second sub-areas, and at least two of the plurality of second sub-areas have different refresh times.

2. The display apparatus according to claim 1, wherein the plurality of first sub-areas are configured to be refreshed to switch a polarization state of light passing through the plurality of first sub-area.

3. The display apparatus according to claim 1, wherein the plurality of first sub-areas are arranged in a first direction, the first direction being consistent with a refresh scanning direction of the display area.

4. The display apparatus according to claim 3, wherein
the refresh time for at least one of the plurality of first sub-areas is the same as that for at least one corresponding row of pixels in the display area.

5. The display apparatus according to claim 4, wherein
an i^{th} one of the plurality of first sub-areas is arranged in a path of emitted light from a j^{th} one of the plurality of second sub-areas, and the refresh time for the i^{th} one of the plurality of first sub-areas is the same as that for at least one row of pixels in the j^{th} one of the plurality of second sub-areas, where i and j are both positive integers.

6. The display apparatus according to claim 5, wherein
the refresh time for at least one of the plurality of first sub-areas is the same as that for a central row of pixels in a corresponding one of the plurality of second sub-areas.

7. The display apparatus according to claim 6, wherein
the j^{th} one of the plurality of second sub-areas comprises m pixel rows, where m≥2 and is an integer;
in the case that m is even, the refresh time for the i^{th} one of the plurality of first sub-areas is the same as that for a (m/2)^{th} row of pixels or a ((m/2)+1)^{th} row of pixels in the j^{th} one of the plurality of second sub-areas; and
in the case that m is odd, the refresh time for the i^{th} one of the plurality of first sub-areas is the same as that for a ((m+1)/2)^{th} row of pixels in the j^{th} one of the plurality of second sub-areas.

8. The display apparatus according to claim 5, wherein a quantity of the plurality of first sub-areas and a quantity of the plurality of second sub-areas are the same and each greater than 2.

9. The display apparatus according to claim 1, wherein the plurality of first sub-areas are arranged in the first direction, and each of the plurality of first sub-areas has a same length in the first direction.

10. The display apparatus according to claim 1, wherein the plurality of first sub-areas are arranged in the first direction, and at least two of the plurality of first sub-areas have different lengths in the first direction.

11. The display apparatus according to claim 10, wherein in the first direction, a length of a p^{th} one of the plurality of first sub-areas is Lp, a length of a k^{th} one of the plurality of first sub-areas is Lk, and Lp<Lk; in the case that the p^{th} one of the plurality of first sub-areas is closer to a center of the polarization modulator than the k^{th} one of the plurality of first sub-areas.

12. The display apparatus according to claim 1, wherein the plurality of first sub-areas are arranged in the first direction and each comprises an electrode, and Ld<Lm, where Ld is a distance between two electrodes of two adjacent ones of the plurality of first sub-areas in the first direction, and Lm is a length of a minimum one of the plurality of first sub-areas is Lm.

13. The display apparatus according to claim 1, wherein the plurality of first sub-areas are arranged in the first direction and each comprises an electrode, and a distance between two electrodes of two adjacent ones of the plurality of first sub-areas in the first direction is less than a first preset threshold, the first preset threshold being less than or equal to 10 μm.

14. The display apparatus according to claim 1, wherein a distance between a light output surface of the backlight module and the polarization modulator is D, where D≤10 mm.

15. The display apparatus according to claim 14, wherein D≥1 mm.

16. The display apparatus according to claim 14, wherein the light output surface of the backlight module is connected to the polarization modulator by an optical adhesive layer.

17. The display apparatus according to claim 1, wherein the plurality of first sub-areas are arranged in the first direction; a projected cross-section of the light emitted by the backlight module onto the polarization modulator has a length of X in the first direction, and a total length of the plurality of first sub-areas in the first direction is Y, where X<Y/2.

18. The display apparatus according to claim 17, wherein an i^{th} one of the plurality of first sub-areas is arranged in a path of light emitted by pixels in the backlight module, and a length of the i^{th} one of the plurality of first sub-areas in the first direction is Li, where X<Li.

19. The display apparatus according to claim 1, wherein the display apparatus comprises the backlight modules in a quantity of n, where n≥2 and n is an integer, and the display apparatus further comprises a color combiner and a shifter, the color combiner being configured to combine colors of light emitted by the n backlight modules and then transmit color-combined light to the polarization modulator, and the polarization modulator being configured to transmit modulated light to the shifter.

20. The display apparatus according to claim 19, wherein the n backlight modules have the same refresh time.

21. The display apparatus according to claim 20, wherein the n backlight modules each comprise a same quantity of pixel rows, and pixel rows configured for color combination together in the n backlight modules have the same refresh time.

22. The display apparatus according to claim 1, wherein the display apparatus comprises the backlight modules in a quantity of n and the polarization modulators in a quantity of n, and further comprises a color combiner and a shifter, the n backlight modules and the n polarization modulators being arranged in one-to-one correspondence, the n polarization modulators being configured to modulate light emitted by the n backlight modules respectively and transmit the modulated light to the color combiner, and the color combiner being configured to combine colors of light output by the n polarization modulators and then output the color-combined light to the shifter, where n≥2 and n is an integer.

23. The display apparatus according to claim 19, wherein at least one of the n backlight modules is configured to emit monochromatic light.

24. The display apparatus according to claim 1, wherein the backlight module comprises sub-pixels of first to N^{th} colors, a same row of sub-pixels of different colors are refreshed simultaneously, and the polarization modulator is configured to modulate light emitted from the backlight module and then transmit the modulated light to the shifter.

25. The display apparatus according to claim 1, wherein the backlight module comprises sub-pixels of first to N^{th} colors, one period of the backlight module comprises N sub-periods in sequence, and the sub-pixels of the N^{th} color emit light in the N^{th} sub-period; and
in any of the N sub-periods, the at least two of the plurality of first sub-areas have the different refresh time.

26. The display apparatus according to claim 1, wherein
the at least two of the plurality of first sub-areas are arranged in a direction perpendicular to a refresh scanning direction of the display area; and the refresh times for the at least two of the plurality of first sub-areas are the same as refresh times for different pixel rows in the display area respectively.

27. The display apparatus according to claim 26, wherein the plurality of second sub-areas comprise an e^{th} second sub-area and an f^{th} second sub-area, a refresh time for one of the plurality of first sub-areas being the same as that for at least one row of pixels in the e^{th} second sub-area, and a refresh time for another one of the plurality of first sub-areas being the same as that for at least one row of pixels in the f^{th} second sub-area.

28. The display apparatus according to claim 1, wherein
the at least two of the plurality of second sub-areas are arranged in a direction perpendicular to a refresh scanning direction of the display area; and
the at least two of the plurality of second sub-areas have different refresh times, and the two of the plurality of second sub-areas having the different refresh times have a same refresh frequency.

29. The display apparatus according to claim 28, wherein the plurality of first sub-areas are arranged in the first direction consistent with the refresh scanning direction of the display area.

30. A projection system, comprising a display apparatus, comprising:
a backlight module comprising a display area; and
a polarization modulator located in a path of emitted light from the backlight module and comprising a plurality of first sub-areas,
wherein at least two of the plurality of first sub-areas have different refresh times, and/or the display area comprises a plurality of second sub-areas, and at least two of the plurality of second sub-areas have different refresh times.
